(19) United States
(12) Patent Application Publication
(10) Pub. No.: US 2012/0026668 A1
(43) Pub. Date: Feb. 2, 2012

(54) MASS STORAGE RETENTION, INSERTION, AND REMOVAL IN A CONDUCTION COOLED SYSTEM AND STACKING HARD DRIVE BACKPLANE

(76) Inventor: Trevor Landon, (US)

(21) Appl. No.: 12/847,446

(22) Filed: Jul. 30, 2010

(51) Int. Cl. G06F 1/16

(52) U.S. Cl. 361/679.31

(57) ABSTRACT

A stacking hard drive and backplane architecture allowing for systems with multiple hard drive configurations to be designed and produced while maintaining a standard common backplane between the various different end systems. An internal server assembly is internally arranged for vertical alignment of components enabling a dense architecture while effectively addressing thermal concerns and preventing components from overheating during use.

### BACKGROUND OF THE INVENTION

1. Field of the Invention

The present invention relates generally to computer systems. More specifically, it relates to improvements in the architecture of servers, particularly as it relates to the ability to hot swap hard disc drives and other components in the server and to effectively prevent the components from overheating during use.

2. Description of Related Art

Rack-optimized servers can have severe volumetric constraints resulting from market demand for multiple features and extensive functionality implemented within a chassis with a limited vertical height and limited depth. For example, a chassis is configured to house hard disk drives, Peripheral Component Interconnect (PCI) cards, processors, memory, and others. In conventional configurations, chassis depth is commonly defined and limited by cable management constraints. For example, standard 36-inch deep racks may be the maximum allowable in light of bulkiness and/or electromagnetic interference reduction for rack input/output and power cable constraints.

Hard disk drives have been designed to make electrical and power connection to server electronics via a vertical backplane. A backplane is used to attach many disk drives together and serves as a means for distributing power, data, and controls to each connected disk drive. Common prior art backplane configurations include a single physical device throughout which all of the power, data, and controls are distributed. The backplane is typically a single motherboard which is physically similar to a wall, where the disk drives are attached to one side of the wall. This physical arrangement is possible, because disk drives need access to only one side of the backplane in order to be installed in and removed from the backplane.

All power, data, and controls may be routed to each drive using the single motherboard backplane. The aforementioned arrangement may consume a significant amount of the total available chassis depth, for example, due to the alignment of the longest dimension of the hard disk drive with chassis depth. Currently, hard drive backplanes are designed in many configurations based on the available space in the server package. For example, some are 2×3 (2 rows, 3 columns), 3×1, 1×2, 6×1, etc. This, however, may typically place the backplane in a position perpendicular to the hard disk. However, this configuration may only support hard disk placement in limiting fashion within the prescribed area of a given computer chassis. Accordingly, due to the perpendicular arrangement of conventional backplane systems, the shape of the backplane connector may impede the possible number of hard disc drives fitted within a chassis system. If, however, additional disk drives are needed to meet system criteria, the aforementioned perpendicular arrangement of the backplane may force a larger chassis design due to the limited acceptability of the hard disks within the chassis. Building specialized chassis designs to accommodate a necessary amount of hardware capabilities, such as a prescribed number of mass storage devices, can increase operative costs and effort for generating a required system. Thus, the aforementioned perpendicular design of convention backplanes may not only be inefficient for certain system applications, but may also increase manufacturing costs for specialized designs to compensate for the limiting perpendicular backplane architecture.

A further difficulty may occur with the placement of the backplane in a position perpendicular to the hard disk and, hence, to the airflow required to cool components, for example, down-stream of the hard drive(s) with the connectors normal to the backplane. With a conventional vertical backplane arrangement, the backplane acts as a solid impediment positioned essentially perpendicular to airflow pathways. The aforementioned backplane design may also hinder heat transfer around the backplane device. Accordingly, the vertical backplane forms a blockage which obstructs airflow, creating a significant airflow resistance. As computing power density increases, so does the heat that must be forced from the inside of the system to the environment external to the system. To properly draw the heat from the machine, the volumetric air flow through the system must be increased. A backplane oriented normal to the air flow greatly hinders this flow.

Additionally, the various electronic devices within the server are designed to operate within a certain range of temperatures. If a device, such as a hard disc drive (HDD), is required to operate outside of its normal operational temperature range, problems, such as malfunctions, erratic behavior and damage, are likely to occur. Generally speaking, the heat generated by a single HDD is not likely to create a serious problem. The heat could be dissipated by relying on a relatively simple system fan. However, as disc speeds have become faster, the amount of heat generated by the HDD has also increased. This problem is further exacerbated when multiple HDDs are placed in close proximity to one another within an enclosure. The ability of the system to create airflow sufficient to cool the individual disc drives becomes encumbered by the blocking effect of the surrounding drive units. Accordingly, the disc drives in this environment may be likely to develop heat-related problems.

In the past, attempts have been made to provide adequate cooling. For example, designers implementing vertical backplanes will typically perforate the backplane with holes to allow as much airflow as possible. This, however, can be problematic, because this procedure can limit the amount of backplane board available for providing the structural support and electrical characteristics sufficiently required by the system. Other attempts have included cooling fans which have been implemented in combination with ventilated cases in order to reduce the likelihood of heat build-up. However, this design is not purposeful in systems which are completely sealed, for example, such as those utilized in specialized environments/circumstances and having little or no air flow. Other attempts to address impeded airflow and heat build-up have included elaborate cooling systems, including refrigeration or cooling fins, or increasing the spacing between adjacent disc drives. Unfortunately, these methods not only increase the complexity of the system but also increase the overall size of the system, whereas the trend is to miniaturize the systems wherever and whenever possible especially for specific/special operating environments.

Accordingly, a need exists for interconnecting hard drives in a modular configuration yet capable of retaining key advantages of non-modular techniques predominately used in industry. There is also a need for implementing the hard drive interconnection without impeding air flow or contributing to thermal concerns generated by conventional backplane systems.

### SUMMARY OF THE INVENTION

The present invention provides a stacking hard drive backplane architecture allowing for systems with multiple hard drive configurations to be designed and produced while maintaining a standard common backplane between the various different end systems. An internal server assembly is internally arranged for vertical alignment of components enabling a dense architecture while effectively addressing thermal concerns and preventing components from overheating during use.

Still other aspects, features and advantages of the present invention are readily apparent from the following detailed description, simply by illustrating a number of exemplary embodiments and implementations, including the best mode contemplated for carrying out the present invention. The present invention also is capable of other and different embodiments, and its several details can be modified in various respects, all without departing from the spirit and scope of the present invention. Accordingly, the drawings and descriptions are to be regarded as illustrative in nature. and not as restrictive.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 provides a perspective view of a server according to an exemplary disclosed embodiment;

FIG. 2 provides a front view of the server of FIG. 1 having a removed cover plate according to an exemplary disclosed embodiment;

FIG. 3 illustrates mass storage devices removed from the chassis of the server of FIG. 1 according to an exemplary disclosed embodiment;

FIG. 4 illustrates a system board and heatsink/mass storage device retention assembly provided in the server of FIG. 1 having mass storage devices removed according to an exemplary disclosed embodiment;

FIG. 5 illustrates the system board with heatsink/ mass storage device retention assembly of FIG. 4 having installed mass storage devices according to an exemplary disclosed embodiment;

FIG. 6A illustrates a backplane connection for a single mass storage device according to an exemplary disclosed embodiment; and

FIG. 6B illustrates a backplane connection for multiple mass storage devices according to an exemplary disclosed embodiment.

### DETAILED DESCRIPTION

An improved stacking hard drive and backplane design is described. The present invention provides a stacking hard drive and backplane assembly architecture allowing for systems with multiple hard drive configurations to be designed and produced while maintaining a standard common backplane between the various different end systems. In the following description, for purposes of explanation, numerous specific details are set forth in order to provide a thorough understanding of the exemplary embodiments. It is apparent to one skilled in the art, however, that the present invention can be practiced without these specific details or with an equivalent arrangement.

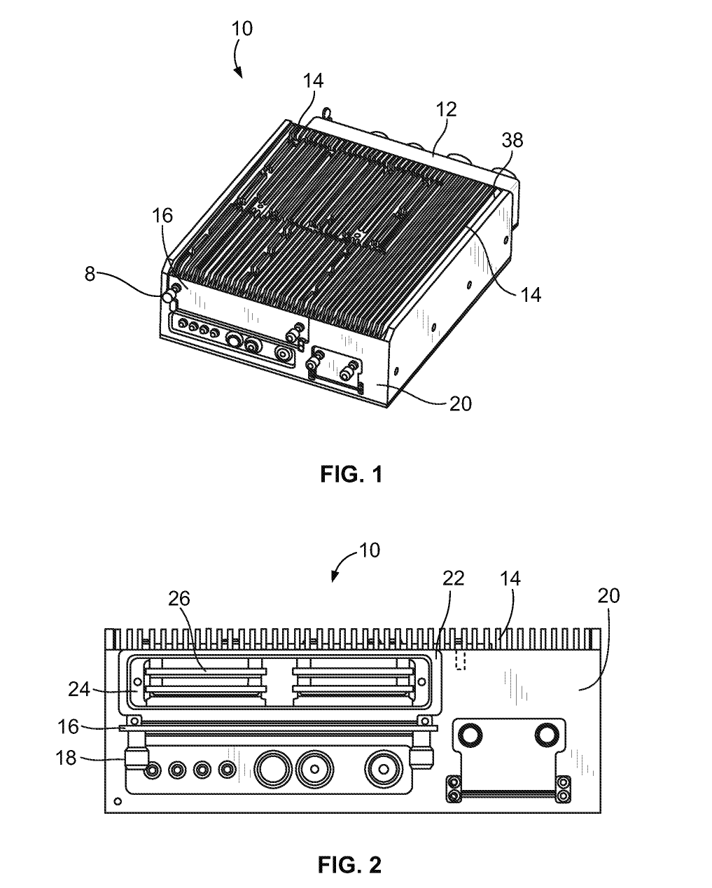

Referring now to the drawings, wherein like reference numerals designate identical or corresponding parts throughout the several views, FIG. 1 illustrates a server 10 internally arranged for vertical alignment of components enabling a dense architecture. Server 10 comprises an exterior case or chassis 12 for lodging and protecting internal components. The chassis 12 may be configured to support mounting capabilities as needed. A plurality of fins 14 are integrally configured into the body of the chassis 12 forming an outer heatsink surface. In other arrangements, fins 14 may be removable attached. The front 20 of chassis 12 may include a cover plate 16 for accessing internal components of the server. The cover plate 16 may be secured to the chassis 12 by any appropriate securing means sufficient for securing the cover plate 16 in tight fit relation to the chassis 12 framing and sealed arrangement. In one embodiment, threaded fasteners 18 are provided to secure the cover plate 16 to chassis 12.

FIG. 2 illustrates a front view of server 10 having cover plate 16 removed from the chassis 12 body. With cover plate 16 removed, access is gained through the cover plate opening 22 to internal components of server 10. In the present embodiment, the cover plate opening 22 provides access to, at least, a heatsink/mass storage device retention assembly and a corresponding number of one or more mass storage devices 26. While one or more known computer bus interface designs may be supported by the present system, server 10 is preferably configured to support the Serial ATA (SATA)(Serial Advanced Technology Attachment) computer bus interface for connecting host bus adapters to mass storage devices such as hard disk drives and optical drives.

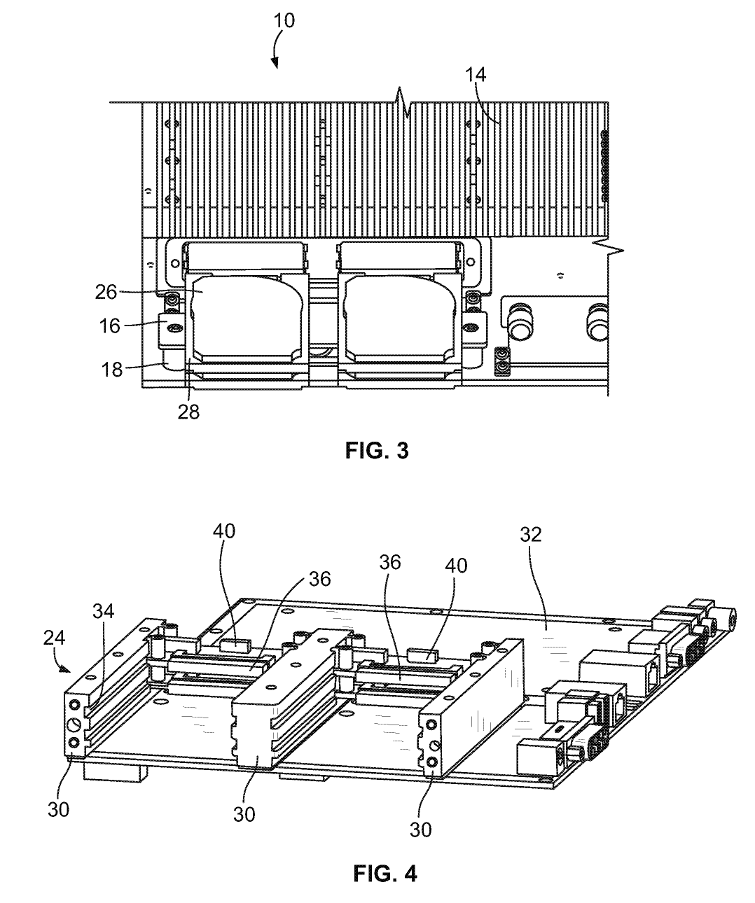

Turning to FIG. 3, a plurality of SATA disc drives 26 are shown removed from chassis 12 of the server 10 system. These mass storage drives 26 are provided with mountable rails 28 for retaining the drives in a final assembly. The mountable rails 28 act as a rail system for mounting and retaining the mass storage device 26. For example, turning to FIG. 4, the heatsink/mass storage device retention assembly 24 is configured to retain the mass storage devices 26 via a rail insertion feature. This feature is incorporated, for example, into a plurality machined of aluminum blocks 30 of the heatsink/mass storage device retention assembly 24. The aluminum blocks 30 are disposed internally to chassis 12 and may act as internal structural support members to chassis 12. Areas of aluminum blocks 30 may be attached to chassis 12 at selected points. In one disclosed embodiment, aluminum blocks 30 are screwed to the top of chassis 12. A thermal compound may be used on the interface between the aluminum blocks 30 and the chassis 12 to maximize thermal transfer therebetween. However, it should be readily understood that other methods may be employed for securing the aluminum blocks 30 to chassis 12 in realizing the spirit and scope of the invention. For example, the aluminum blocks 30 may be integrated directly into the structure of chassis 12. in which, for example, the top of chassis 12 and aluminum blocks 30 are machined from a single block of material as a single integrated piece.

Disclosed embodiments include aluminum blocks 30 preferably attached to the top of a system board or motherboard 32 at prescribed locations thus forming contact areas between the aluminum blocks 30 and motherboard 32. The contact area may be determined based upon selected criteria including, for example, a size of an area on motherboard 32 required to support a number of disc drives 26 and/or the attachment method utilized to secure the aluminum blocks 30 to motherboard 32. Further, the determination of the contact area may also be influenced by the area required to conduct a heat load from motherboard 32 to chassis 12. By way of example, a plurality of fasteners, such as screws, may be utilized to attach the aluminum blocks 30 to motherboard 32.

The motherboard 32 is preferably designed to contain specific thermal zones which are intended to be in direct contact with metal. These thermal zones include structures in the motherboard 32 specifically designed to transfer heat from the core of the motherboard 32 to the outer heatsink surface. This may occur via conduction of heat from the motherboard 32 through aluminum blocks 30 and to chassis 12 as further explained below. To facilitate heat transfer, the surface of the motherboard 32 which contacts the aluminum blocks is preferably constructed of bare copper.

In a preferred embodiment, the platform system board is a ComExpress baseboard capable of supporting a COMExpress module. COMExpress, a computer-on-module (COM) form factor, is a highly integrated and compact PC that can be used in a design application much like an integrated circuit component. Each COMExpress Module COM integrates core CPU and memory functionality, the common I/O of a PC/AT, USB, audio, graphics, and Ethernet. In some embodiments, all I/O signals may be mapped to high density, low profile connectors attached to the module. The COMExpress solution offers a dense package computer system for use in small or specialized applications requiring low power consumption or small physical size as is needed in embedded systems. Some devices may also incorporate Field Programmable Gate Arrays. COMExpress is an open standard technology which may offer more compact and powerful computing solutions than, for example, blade-based computer systems.

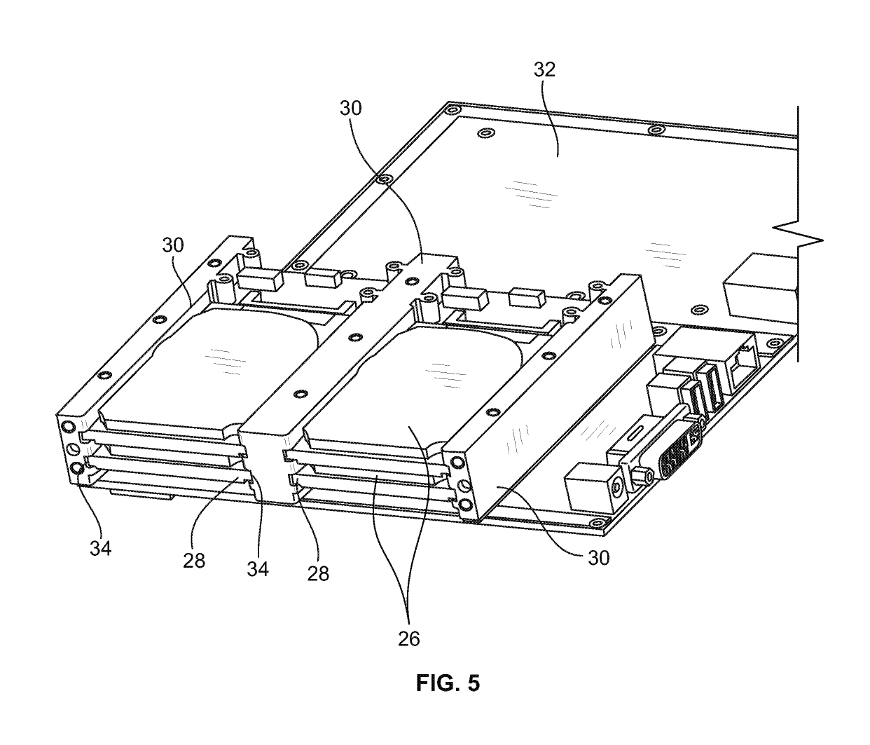

Each of the aluminum blocks 30 contain rail channels 34 configured to accept corresponding rails 28 of mass storage devices 26 during assembly. Turning to FIG. 5, the rails 28 of respective mass storage devices 26 are inserted within a corresponding number of rail channels 34 of aluminum blocks 30. For illustrative purposes, four mass storage devices 26 are shown throughout the drawings, however, more or less mass storage devices may be employed by the invention as needed. The aluminum blocks 30 are sufficiently spaced to allow a tight fit connection and retention of the mass storage devices 26 within the rail channels 34 after insertion. The aluminum blocks 30 may be designed to be integral to the chassis 12. Hence, no additional or separate dedicated system is necessary within the chassis 12 for supporting/retaining the mass storage device(s) 26 as is common in other prior art devices/systems. This facilitates efforts to provide a dense capacity of electronic elements within the prescribed area of the described system and chassis design. Thus, the present embodiment utilizes its existing chassis elements to not only structurally support the chassis 12 but provides additional retention features for supporting and retaining additional electrical devices such as mass storage device 26.

An advantage provided by the chassis 12 system described herein compensates for a sealed system having relatively little or no airflow. The present system relies upon conduction to dissipate heat from within the chassis 12 to outside of the system. For example, during operation, hot electrical components mounted to the system board 32 are configured to transfer heat through the circuit board to the aluminum blocks 30. In one embodiment, the transfer of heat occurs through direct metal contact from the system board 32 to the aluminum blocks 30. The aluminum blocks 30 effectively act as a heat sink to receive heat generated from electrical components within the system. As such, the aluminum blocks 30 also receive transferred heat generated from the mass storage device(s) 26 through the rails 28 in contact with the rail channels 34. The heat transferred from the mass storage device 26 includes those areas behind the hard drives which are inevitably cooled by the aluminum blocks 30. Since the aluminum blocks 30 are in direct connection the chassis 12, heat is dissipated from the aluminum blocks 30 to chassis elements such as fins 14 thereby transferring heat to a top side 38 of the server 10 and away from the system. Thus, heat is eliminated from the system components by allowing, at least, a combination of the mass storage device 26 rails 28 in connection with the aluminum blocks 30 to become part of the cooling strategy of the overall system. If the server 10 is connected to a larger piece of metal, for example, a mounting structure, the dissipated heat will transfer to that larger piece of metal.

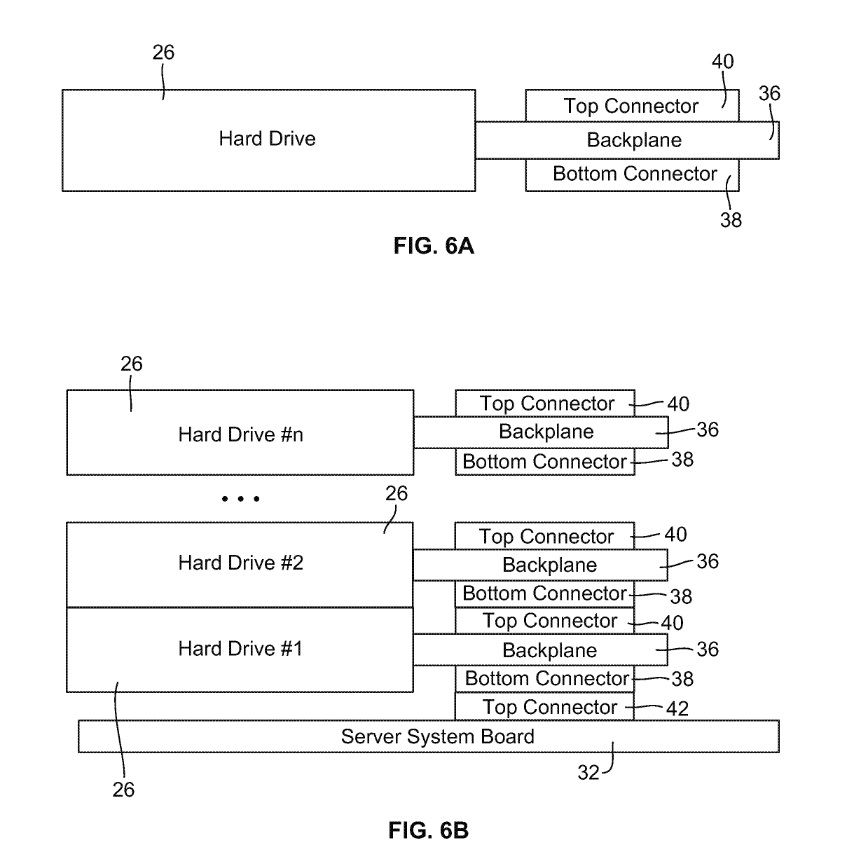

As shown in FIG. 4, respective backplane connectors 36 are provided to mate with a corresponding mass storage device 26. Again, four backplane connectors 36 are shown for illustrative purposes, however, more or less backplane connectors 36 may be configured to accept more or less corresponding mass storage devices 26 as required. The backplane connectors 36 are configured to make an electrical connection to system board 32. Turning to FIG. 6A, disclosed embodiments of the invention provide a backplane connector 36 mated with a mass storage device 26. The backplane connector 36 is mated in attachment with the mass storage device 26 such that it is parallel to the hard drive. Thus, the backplane connector 36 does not impede airflow or prevent heat transfer within the internal chassis as described earlier in prior art systems.

Attached to the top of the backplane connector 36 is a top connector 40. The top connector 40 is available for connection to a bottom connector 38 of another mass storage device 26 connected to another respective backplane connecter 36. Turning also to FIG. 4, the top connector 40 of the backplane connector 36 is sufficiently small so as not to impede any airflow or heat transfer within the chassis 12 system. It does, however, provide enough support to adequately connect to another backplane connector 36, as needed, while providing any necessary electrical characteristics to the computer system architecture. Again, since the backplane connector 36 is parallel to the mass storage device 26 air may flow or heat transfer may occur across the backplane board. Accordingly, the presently described invention is superior to prior art connectors including, for example, backplanes having perforated holes.

Attached to the bottom of the backplane connector 36 is a bottom connector 38. The bottom connector 38 is available for connection to a top connector 40 of another mass storage device 26 connected to another respective backplane connecter 36. Alternatively, the bottom connector 38 may also be available for connection to a top connector 42 of another electrical component such as a system server board 32. Similar to the top connector 40, bottom connector 38 is sufficiently small so as not to impede any airflow or heat transfer with the chassis 12 system. Yet, again, the bottom connector 38 provides enough support to adequately connect to another backplane connector 36 or system component (such as system board 32), as needed, while providing any necessary electrical characteristics to the computer system architecture.

An advantage of the stacking hard drive and backplane design of the present invention provides multiple mass storage devices 26 to be configured in connection with a system board 32 via an improved stackable backplane design. As such, the backplane design of the present invention assists efforts to provide a dense capacity of electronic components within the prescribed area of the described system and chassis system. As shown, for example, in FIG. 6B the backplane connector 36 of one mass storage device 26 is configured to connect with either another backplane connector 36 of another respective mass storage device 26 or to the system board 32. Again, the noted design of the backplane connector 36 is parallel to each respective mass storage device 26 so as not to impede airflow or heat transfer around the hard drive as is common with the earlier described prior art systems.

Top and bottom connectors 40, 38 respectively, make it possible to mount backplane connectors 36 vertically, thereby providing a stackable design of mass storage device(s) 26. In a stacked configuration, multiple backplane connectors 36 are mounted vertically by the connections of the top and bottom connectors 40, 38, respectively. Attached to the top of the backplane connector 36 is a top connector 40. The top connector 40 is available for connection to a bottom connector 38 of another mass storage device 26 connected to another respective backplane connecter 36. Attached to the bottom of the backplane connector 36 is a bottom connector 38. The bottom connector 38 is available for connection to a top connector 40 of another mass storage device 26 connected to another respective backplane connecter 36. Alternatively, the bottom connector 38 may also be available for connection to a top connector 42 of another electrical component such as a system server board 32. The top and bottom connectors 40, 38, respectively, remain sufficiently small so as not to impede any airflow or heat transfer with the chassis 12 system. Yet, again, top and bottom connectors 40, 38, respectively, provide enough support to adequately connect to another backplane connector 36 or system component (such as system board 32), as needed, while providing any necessary electrical characteristics to the computer system architecture. The prescribed configuration, as described herein, provides a backplane arrangement conducive to maximizing an increased number of mass storage device 26 available for use within the chassis 12 system. This is due to the parallel orientation of the backplane connector 36 with respect to the mass storage device 26.

The interconnect between the connectors, as shown, in FIG. 6B is as follows:
Bottom Connector
Position 1, Channel 1
Position 2, Channel 2
Position 3, Channel 3
. . .
Position n, Channel n
Top Connector
Position 1, Channel 2
Position 2, Channel 3
Position 3, Channel 4
. . .

Position n−1, Channel n
Position n
Hard Drive #1
Channel 1
Hard Drive #2
Channel 1
Hard Drive #n
Channel n
   This approach allows routing of up to n hard drives over the stacking connectors, and supports stacked hard drive configurations from 1 to n. The hard drives in the stacked backplane strategy start with Channel 0 at the bottom of the stack, and end with Channel n in the top position if n backplanes are used.

Moreover, other implementations of the invention will be apparent to those skilled in the art from consideration of the specification and practice of the invention disclosed herein. Various aspects and/or components of the described embodiments may be used singly or in any combination. It is intended that the specification and examples be considered as exemplary only, with a true scope and spirit of the invention being indicated by the following claims.

1. (canceled)

2. A computer assembly comprising:
a computer chassis;
a system board; and
a support structure for receiving one or more mass storage devices, wherein said support structure is in contact with said system board and said computer chassis.

3. The computer assembly of claim 2, wherein the support structure is removably attached to said computer chassis and system board.

4. The computer assembly of claim 3, wherein the support structure is attached to said computer chassis and system board via a plurality of fasteners.

5. The computer assembly of claim 4, wherein a thermal compound is interfaced between the support structure and the computer chassis.

6. The computer assembly of claim 2, wherein the support structure is formed integrally to the structure of the computer chassis.

7. The computer assembly of claim 2, wherein the support structure comprises one or more machined aluminum blocks configured to receive one or more mass storage devices.

8. The computer assembly of claim 7, wherein the one or more mass storage devices comprises a first device for being received by a mating portion of a corresponding one or more machined blocks.

9. The computer assembly of claim 8, wherein the first device comprises a railing and the mating portion comprises rail channels for receiving said railing.

10. The computer assembly of claim 2, wherein the support structure is disposed at selected contact areas of the system board.

11. The computer assembly of claim 10, wherein the selected contact areas comprise thermal zones for transferring heat from the system board to the support structure.

12. The computer assembly of claim 2, wherein the computer chassis comprises a plurality of fins integrally formed into the body of the chassis thereby forming an outer heatsink surface.

13. The computer assembly of claim 2, wherein the system board supports computer-on-module (COM) format.

14. The computer assembly of claim 2, wherein the system board supports COMExpress format.

15. The computer assembly of claim 2, wherein the system board supports Serial Advanced Technology Attachment (SATA) technology.

16. A computer assembly comprising:
a computer chassis;
a system board; and
a support structure for receiving on or more mass storage devices disposed internal to said computer chassis, said support structure in contact with said system board and said computer chassis.

17. An apparatus comprising:
a mass storage device;
a backplane mounted parallel to and in connection with said mass storage device and further connected to a system motherboard.

18. The apparatus of claim 17 further comprising:
a support structure for supporting the mass storage device.

19. An apparatus comprising:
a first series of one or more mass storage devices;
a backplane mounted parallel to and in connection with said first series of one or more mass storage devices;
another one or more series of one or more mass storage devices; and
respective backplanes mounted parallel to and in connection with said another one or more series of one or more mass storage devices, wherein each backplane is connected to a system motherboard.

20. The apparatus of claim 19 further comprising:
a support structure for supporting said first series of one or more mass storage devices and said another one or more series of one or more mass storage devices.

21. A computer assembly comprising:
a system board;
a support structure;
a mass storage device received and supported by said support structure; and
a backplane comprising a backplane connector mounted parallel to and in connection with said mass storage device, said backplane also having a connector connected to the system motherboard.

22. The apparatus of claim 21, wherein the support structure is in contact with the system board.

23. The apparatus of claim 22, further comprising:
a computer chassis, wherein the support structure is removably attached to said computer chassis.

24. The apparatus of claim 22, further comprising:
a computer chassis, wherein the support structure is formed integrally with the structure of the computer chassis.

25. The computer assembly of claim 21, wherein the support structure comprises one or more machined aluminum blocks configured to receive one or more mass storage devices.

26. The computer assembly of claim 21, wherein the support structure is disposed at selected contact areas of the system board.

27. The computer assembly of claim 26, wherein the selected contact areas comprise thermal zones for transferring heat from the system board to the support structure.

28. The computer assembly of claim 23, wherein the computer chassis comprises a plurality of fins integrally formed into the body of the chassis thereby forming an outer heatsink surface.

29. The computer assembly of claim 21, wherein the system board supports computer-on-module (COM) format.

30. The computer assembly of claim 21, wherein the system board supports COMExpress format.

31. The computer assembly of claim 21, wherein the system board supports Serial Advanced Technology Attachment (SATA) technology.

32. A computer assembly comprising:
a system board;
a support structure;
a first series of one or more mass storage devices supported by said support structure;
a backplane mounted parallel to and in connection with said first series of one or more mass storage devices, said backplane also having a connector connected to the system motherboard;
another one or more series of one or more mass storage devices received and supported by said support structure; and
respective backplanes mounted parallel to and in connection with said another one or more series of one or more mass storage devices, said respective backplanes also having a connector connected to the system.

33. A computer assembly comprising:
a system board;
a support structure;
a plurality of mass storage devices received and supported by said support structure; and
a plurality of backplane connectors mounted parallel to and in connection with a respective one of each of said mass storage devices, each of said plurality of backplane connectors also connected to one another, and one backplane connector connected to the system motherboard.

34. A computer assembly comprising:
a computer chassis;
a system board;
a support structure disposed in contact with the system board and the computer chassis;
a plurality of mass storage devices received and supported by said support structure; and
a plurality of backplane connectors mounted parallel to and in connection with a respective one of each of said mass storage devices, each of said plurality of backplane connectors also connected to one another, and one backplane connector connected to the system motherboard.

35. The computer assembly of claim 34, wherein the support structure is integrally formed into the structure of the computer chassis.

36. The computer assembly of claim 34, wherein the support structure comprises one or more machined aluminum blocks configured to receive the plurality of mass storage devices.

37. The computer assembly of claim 34, wherein the computer chassis comprises a plurality of fins integrally formed into the body of the chassis thereby forming an outer heatsink surface.

38. A system for cooling a computer assembly comprising:
means for displacing heat from a system board and electrical components coupled thereto; and
means for receiving the displaced heat and transferring said displaced heat to a means for dissipating said displaced heat exterior to the computer assembly.

39. The system of claim 38, wherein said displacing means comprises selected contact areas of the system board including thermal zones for transferring heat from the system board to the receiving means.

40. The system of claim 38, wherein said receiving means comprises one or more aluminum blocks in contact with the system board and the dissipating means.

41. The system of claim 38, wherein said dissipating means comprises computer chassis having a plurality of fins integrally formed into the body of the chassis thereby forming an outer heatsink surface.
